(19) United States
(12) Patent Application Publication
(10) Pub. No.: US 2013/0028703 A1
(43) Pub. Date: Jan. 31, 2013

(54) APPARATUS THAT CONVERTS BETWEEN ADJUSTABLE TRAILER AND TRUCK BED COVER

(71) Applicant: Ricky Dean Popejoy, Blackfoot, ID (US)

(72) Inventor: Ricky Dean Popejoy, Blackfoot, ID (US)

(21) Appl. No.: 13/560,026

(22) Filed: Jul. 27, 2012

Related U.S. Application Data
(60) Provisional application No. 61/512,210, filed on Jul. 27, 2011.

(51) Int. Cl. B62D 63/06; B23P 17/00; B60P 1/00; B60P 7/02; B60P 3/07

(52) U.S. Cl. 414/812; 280/30; 29/401.1

(57) ABSTRACT

An apparatus that is changeable between a trailer configuration, in which the apparatus is configured and usable as a trailer, and a truck bed cover configuration, in which the apparatus is configured and usable as a truck bed cover. The apparatus includes a bed having a top surface, a wheel assembly attached to the bed, and a towing assembly coupled with the bed, the towing assembly being configured to couple with a hitch of a vehicle. The bed can include a center deck section and a pair of side deck sections slidably coupled to the center deck section such that the side deck sections can be slid laterally with respect to the center deck section to adjust the width of the apparatus. A method of converting the apparatus from a trailer to a truck bed cover is also included.

### CROSS-REFERENCE TO RELATED APPLICATIONS

This application claims priority to U.S. Provisional Patent Application No. 61/512,210, entitled APPARATUS THAT CONVERTS BETWEEN ADJUSTABLE TRAILER AND TRUCK BED COVER and filed on Jul. 27, 2011, the contents of which are incorporated herein by specific reference.

### BACKGROUND OF THE INVENTION

1. The Field of the Invention

The present invention relates to motor vehicle accessories. Specifically, the present invention relates to apparatuses that can convert between trailers and truck bed covers.

2. The Relevant Technology

All-terrain vehicles (ATVs) are used extensively for many activities. For example, ATVs can be used to get to and from hunting spots or camping sites, to help accomplish work in the yard, to recreate with, and even to plow snow, etc. Usually, ATVs are hauled to the location where they are to be used. This is typically accomplished by securing the ATVs to a trailer and towing the trailer behind a truck or similar vehicle. The trailer is a standard size, legal for road use.

Once the ATV is removed from the trailer, the ATV can be used to travel along the narrow trails and roads prevalent in the mountains and back country. As noted above, an ATV can be used to travel to a hunting spot or camping site. For those activities, the gear needed for hunting and/or camping is typically stored in the storage compartments of the ATV, if there are any. However, oftentimes more storage capacity is needed for the extra equipment. For those times, a separate trailer can be hooked up to the ATV to carry the extra equipment. Alternatively, the trailer attached to the ATV can be used during hunting season to carry a downed deer or the like back to the truck. The ATV trailer is smaller than the truck trailer, being much narrower to accommodate the narrow dirt roads and trails over which the ATV travels.

Thus, two separate trailers are required, one for the truck to pull and on which the ATV is mounted, and one for the ATV to pull. It would be an improvement in the art to have a single trailer that was able to convert between a size required for a truck trailer and a size required for an ATV trailer. Then only one trailer could be used.

In addition, there are times when it becomes necessary to transport the ATVs or other loads on the truck instead of on a trailer towed behind the truck. For example, when the road is heavily rutted or otherwise in bad shape, a trailer may not be able to be pulled therethrough. In that condition, the ATVs would not be able to be hauled on the road unless they could be positioned on the truck.

Thus, it would also be an improvement in the art to have a trailer that could convert into a truck bed cover onto which ATVs can be secured.

Furthermore, many conventional truck bed covers are stationary and can weigh a lot. Therefore, a regular pickup truck, such as a half-ton truck, may not be able to support putting anything heavy on the bed cover because the combined weight becomes too great. In addition, because of the weight of the conventional truck bed cover, it can take three or four people to get the conventional bed cover in and out of the truck.

### SUMMARY OF THE INVENTION

Embodiments of the present invention relate to apparatuses that can convert between trailers and truck bed covers and associated methods.

In one embodiment, an apparatus is disclosed that is changeable between a trailer configuration, in which the apparatus is configured and usable as a trailer, and a truck bed cover configuration, in which the apparatus is configured and usable as a truck bed cover. The apparatus includes a bed having a top surface, a wheel assembly attached to the bed, and a towing assembly coupled with the bed. The towing assembly is configured to couple with a hitch of a vehicle.

The bed can include a center deck section and a pair of side deck sections positioned on either lateral side of the center deck section. Top surfaces of the center deck section and the side deck sections can combine to form the top surface of the bed. The side deck sections can be slidably coupled to the center deck section such that the side deck sections can be slid laterally with respect to the center deck section to adjust the width of the apparatus. The center deck section can include a plurality of channels and the side deck sections can each include a plurality of beams received within the channels. The beams can be slidable within the channels to move the side deck sections laterally with respect to the center deck. In one alternative, the width of the apparatus can be adjustable between about four feet to about eight and a half feet.

The wheel assembly can include one or more axles and two or more wheels each mounted to the one or more axles. The two or more wheels can be configured to roll along the ground and support the bed when the apparatus is in the trailer configuration and to support the bed when the apparatus is in the truck bed cover configuration. The wheels can also be used for positioning the apparatus onto the bed of the truck.

The towing assembly can include a trailer tongue coupled with the bed and a trailer coupler positioned at the end of the trailer tongue. The trailer coupler can be configured to couple with a hitch of a vehicle. The trailer tongue and trailer coupler can be configured to be adjusted or removed from the bed to place the apparatus in the truck bed configuration. The towing assembly can also include a sleeve attached to the underside of the bed. The sleeve can receive the trailer tongue in a telescoping manner.

The apparatus can also include a plurality of jacks attached to the underside of the bed, a rack assembly positioned at the front of the bed, and a winch coupled to the bed.

In one embodiment a method is disclosed. The method includes removing a towing assembly from an apparatus being used as a trailer, positioning the apparatus into a bed of a truck, and securing the apparatus to the truck bed to form a truck bed cover. Positioning the apparatus into the bed of the truck can include positioning one or more ramps to extend between the ground and the truck bed, attaching a cable of a winch to one of the apparatus and the truck, and activating the winch, which is secured to the other of the apparatus and the truck, to pull the apparatus up the ramps and into the bed of the truck.

The method can further include adjusting a size of the apparatus. Adjusting the size of the apparatus can include adjusting the width of the apparatus between about four feet to about eight feet six inches, or adjusting the width of the apparatus to substantially match the width of the truck bed, or adjusting the length of the apparatus to substantially match the length of the truck bed.

The method can further include positioning a load on the bed of the apparatus before the apparatus is positioned into the bed of the truck. The load can be an ATV or a downed animal, such as a deer.

In one embodiment, a trailer is disclosed. The trailer includes a bed, a wheel assembly attached to the bed, and a towing assembly coupled with the bed. The bed has a top surface, and includes a center deck section and a pair of side deck sections positioned on either lateral side of the center deck section. Top surfaces of the center deck section and the side deck sections combine to form the top surface of the bed. The side deck sections are slidably coupled to the center deck section such that the side deck sections can be slid laterally with respect to the center deck section to adjust the width of the trailer. The wheel assembly includes one or more axles and two or more wheels. Each wheel is mounted to the one or more axles. The towing assembly includes a trailer tongue coupled with the bed and a trailer coupler positioned at the end of the trailer tongue. The trailer coupler is configured to couple with a hitch of a vehicle.

In one alternative, the width of the trailer is adjustable between about four feet to about eight and a half feet. The towing assembly can also include a sleeve attached to an underside of the bed and the trailer tongue can be slidable within the sleeve in a telescoping manner. The trailer can also include a plurality of jacks attached to the underside of the bed

In one embodiment, a truck bed cover is disclosed. The truck bed cover includes a bed and a wheel assembly attached to the bed. The bed has a top surface, and includes a center deck section and a pair of side deck sections positioned on either lateral side of the center deck section. Top surfaces of the center deck section and the side deck sections combine to form the top surface of the bed. The side deck sections are slidably coupled to the center deck section such that the side deck sections can be slid laterally with respect to the center deck section to adjust the width of the truck bed cover. The wheel assembly includes one or more axles and two or more wheels. Each wheel is mounted to the one or more axles.

In one alternative, the width of the truck bed cover is adjustable between about four feet to about eight and a half feet. The truck bed cover can also include a plurality of jacks attached to the underside of the bed and can also include a rack assembly positioned at the front of the bed.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope. In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g., “20”) to generally refer to every instance of the element; while the element label will include an appended letter (e.g., “20a”) to refer to a specific instance of the element.

FIGS. 1A and 1B are perspective views of an exemplary apparatus incorporating features of the present invention according to one embodiment;

FIGS. 1C-1F are top, bottom, front, and side views, respectively, of the apparatus shown in FIGS. 1A and 1B;

FIG. 2 is a top view of the system shown in FIGS. 1A and 1B, with the side deck plates moved laterally inward;

FIGS. 3A and 3B are perspective views of an alternative apparatus according to another embodiment;

FIG. 4 is a perspective view of another alternative apparatus, shown in a wide trailer configuration and attached to a truck;

FIG. 5 is a perspective view of the apparatus shown in FIG. 4, depicted in a narrow trailer configuration and attached to the truck;

FIG. 6 is a perspective view of the apparatus shown in FIG. 4, depicted in a narrow trailer configuration and attached to an ATV;

FIGS. 7-12 depict a method of converting the apparatus shown in FIG. 4 from a trailer to a truck bed cover and positioning the truck bed cover in the bed of a truck;

FIGS. 13A and 13B are perspective views showing the apparatus of FIGS. 1A and 1B in the truck bed cover configuration, positioned in the bed of a truck with a pair of ATVs loaded thereon;

FIG. 14 is a perspective view of a tie down bracket according to one embodiment; and

FIGS. 15-17 depict a method of constructing a tent, using the apparatus shown in FIG. 4 as a base for the tent.

### DETAILED DESCRIPTION OF THE PREFERRED EMBODIMENTS

In the following detailed description, reference is made to the accompanying drawings, which form a part hereof In the drawings, similar symbols typically identify similar components, unless context dictates otherwise. The embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It will also be understood that any reference to a first, second, etc. element in the claims or in the detailed description, is not meant to imply numerical sequence, but is meant to distinguish one element from another unless explicitly noted as implying numerical sequence.

In addition, As used in the specification and appended claims, directional terms, such as “top,” “bottom,” “up,” “down,” “upper,” “lower,” “proximal,” “distal,” “left,” “right,” “front,” “back,” “horizontal,” “vertical,” and the like are used herein solely to indicate relative directions and are not otherwise intended to limit the scope of the invention or claims.

The present invention relates to accessories for motor vehicles. More specifically, the present invention relates to apparatuses that can convert between trailers and truck bed covers.

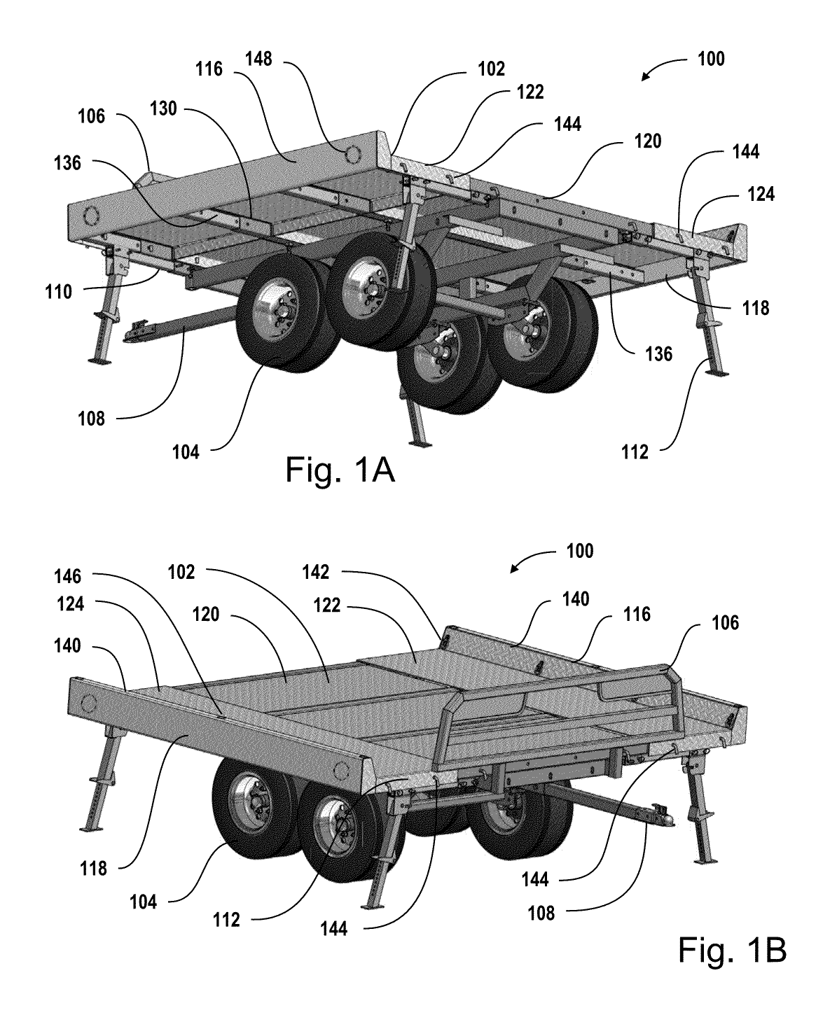

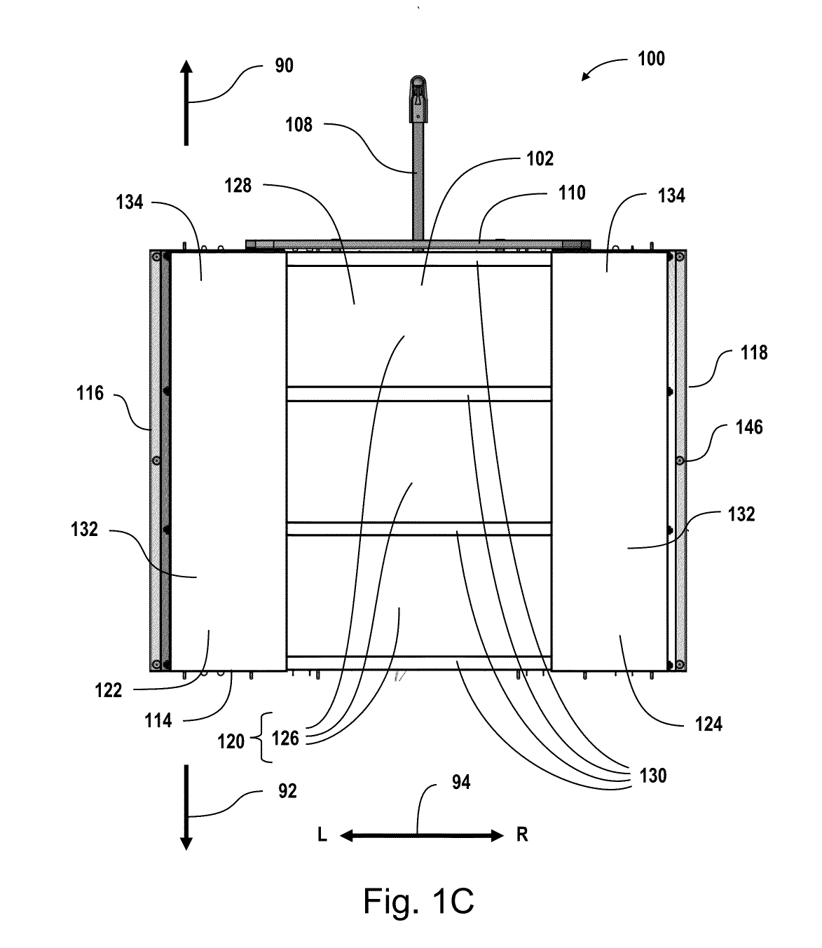

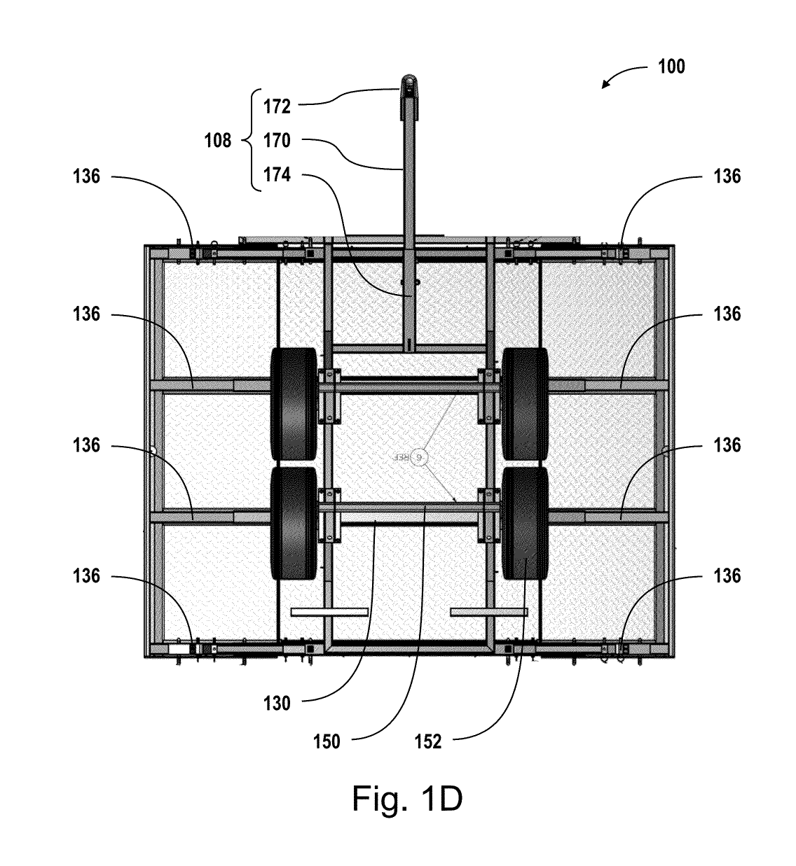

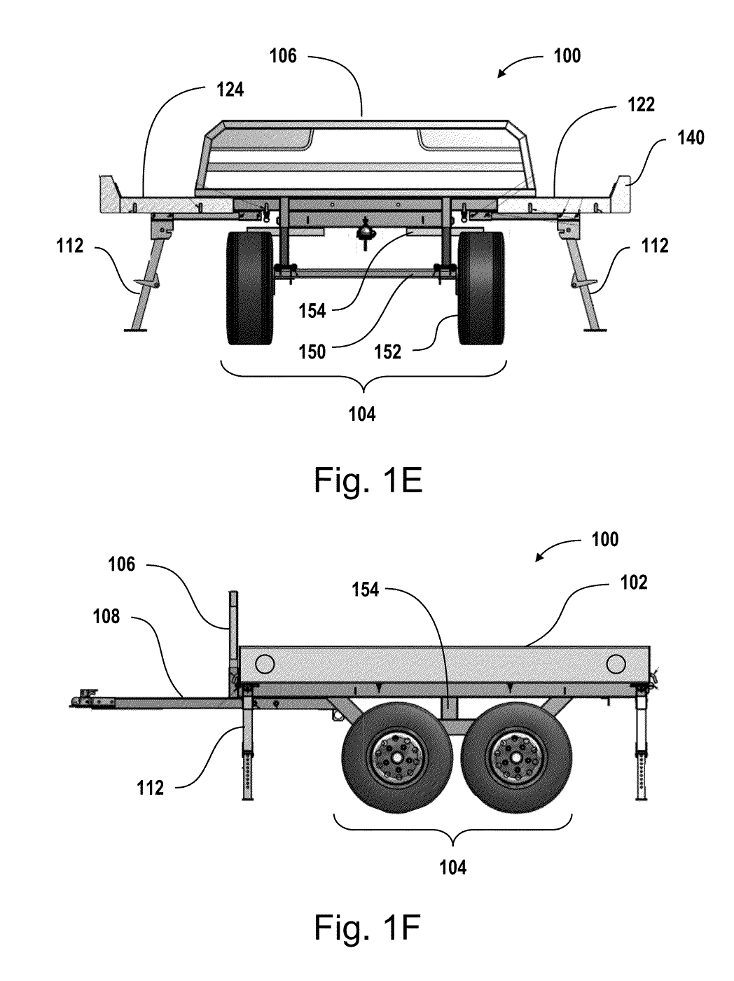

One embodiment of an apparatus 100 that incorporates elements of the present invention is shown in FIGS. 1A-1F. For discussion purposes, the “front” and “rear” directions are those directions respectively represented by arrows 90 and 92 on FIG. 1C. Similarly, the “lateral” direction is represented by arrow 94 on FIG. 1C, with the “left” and “right” directions being respectively represented by “L” and “R” at the ends of the arrow.

Apparatus 100, which may be referred to herein as the “Rack-N-Roll,” can be used for many things. For example, Rack-N-Roll apparatus 100 can be used as a utility trailer, a truck bed cover, a tent holder, and a single or double ATV hauler, among other things. Apparatus 100 includes a bed 102 and a wheel assembly 104. A rack assembly 106 and a towing assembly 108 can be attached to a front end 110 of bed 102 and one or more stabilizer jacks 112 can be attached to the underside of bed 102.

As shown in the depicted embodiment, bed 102 extends between the front end 110 and a back end 114 and between a left side 116 and a right side 118. Bed 102 comprises a center deck plate 120 and left and ride side deck plates 122 and 124 that are slidably coupled with center deck plate 120.

Center deck plate 120 comprises one or more plate sections 126 that collectively form a top surface 128 of the deck plate 120 and one or more channels 130 positioned between the plate sections 126. The channels 130 each project below the top surface 128 of the center deck plate 120 and extend between and laterally beyond the left and right sides of the center deck plate 120. In the depicted embodiment, three separate plate sections 126 and four separate channels 130 are used, although other numbers of plate sections and channels can alternatively be used. The channels 130 are positioned at the front and rear of the center deck plate, as well as between the three plate sections 126. Plate sections 126 can be permanently secured to channels 130 or removably secured thereto. In one embodiment, the rearmost plate section can be removed so that apparatus 100 can be used for ice fishing.

The left and right side deck plates 122 and 124 are respectively positioned on either side of the center deck plate 120. Each of the side deck plates 122 and 124 comprise one or more plate sections 132 that collectively form a top surface 134 of the respective deck plate 122, 124 and one or more beams 136 projecting below the top surface 134 of the deck plate 122, 124 and extending between the left and right sides of the deck plate. In the depicted embodiment, a single plate section 132 and four separate beams 136 are used for each side deck plate 122, 124, although other numbers of plate sections and beams can alternatively be used. However, the number of beams 136 should match the number of channels 130.

The beams 136 are positioned so as to be laterally aligned with channels 130 in center deck plate 120. As such, beams 136 can be received within channels 130 so that left and right side deck plates 122 and 124 can laterally slide with respect to center deck plate 120. As such, the width of bed 102 can be adjusted by sliding left and right side deck plates 122 and 124 with respect to center deck plate 120.

As side deck plates 122 and 124 are slid laterally with respect to center deck plate 120, plate sections 132 of each side deck plate 122 and 124 slide over the top of plate sections 126 of center deck plate 120 so that a top surface of bed 102 is always maintained. Although the top surface of bed 102 is always maintained, the lateral width of the top surface changes based on the positioning of side deck plates 122 and 124. That is, as deck plates 122 and 124 are slid laterally inward (i.e., towards each other), the width of bed 102 decreases and as deck plates 122 and 124 are slid laterally outward (i.e., away from each other), the width of bed 102 increases.

One or more fasteners can be used to secure beams 136 of side deck plates 122 and 124 to channels 130 of center deck plate 120 when in the desired position. For example, a pin 144 can be positioned in aligned holes in channel 130 and corresponding beams 136 to prevent beams 136 from sliding in the channel 130 when the desired position has been obtained. Other securing devices or methods can also be used to secure beams 136 to channels 130. In alternative embodiments, side deck plates 122 and 124 can be secured to center deck plate 120 directly with or without securing beams 136 to channels 130.

Although in the depicted embodiment, the channels 130 are included with the center deck plate 120 and the beams 136 are included with the left and right side deck plates 122 and 124, the opposite can also be used. That is, if desired, the channels 130 can be positioned on the side deck plates 122 and 124 and the beams 136 on the center deck plate 120. Furthermore, instead of the side deck plates 122 and 124 sliding over the center deck plate 120, the center deck plate 120 can slide over the side deck plates 122 and 124.

In an alternative embodiment, channels 130 and beams 136 can comprise telescopic tubing in which channels 130 are sleeves in which beams 136 telescopically slide. In that embodiment, plate sections 132 of side deck plates 122 and 124 are only attached to the beams 136 on the front and rear of apparatus 100 using pins 144; the other beams 136—the middle beams between the front and rear beams—provide support to plate sections 132 without being secured thereto. As such, when pins 144 are removed, plate sections 132 of side deck plates 122 and 124 can be completely removed from the rest of apparatus 100.

In that embodiment, the middle beams 136 are manually pulled laterally outward when the width of apparatus 100 is increased to provide support on the outer edges of plate sections 132. Fasteners, such as pins, can again be used to secure beams 136 to channels 130 at the desired width. A flange can be included on the outer edges of plate sections 132 to catch on the ends of beams 136 and push beams 136 laterally inward when the width of apparatus 100 is decreased. Other variations can also be used, as would be appreciated by one skilled in the art.

An upward facing lip can be formed at or attached to the outer edges of plate sections 132, if desired. For example, in the depicted embodiment, a lip 140 is formed on the outer lateral edges of plate sections 132 of left and right side deck plates 122 and 124. One or more attaching devices, such as an attaching ring 142, can be secured to lip 140 to provide a device to which a rope, strap, or other securing means can be attached. Likewise, one or more mounting holes 146 can be formed in lip 140. Mounting holes 146 can be used to receive poles used in constructing a side wall for the trailer, or poles used to construct a tent on bed 102, as discussed below. Attaching rings 142 and/or mounting holes 146 can alternatively be attached and formed on side deck plates 122 and 124 even if lips 140 are not used.

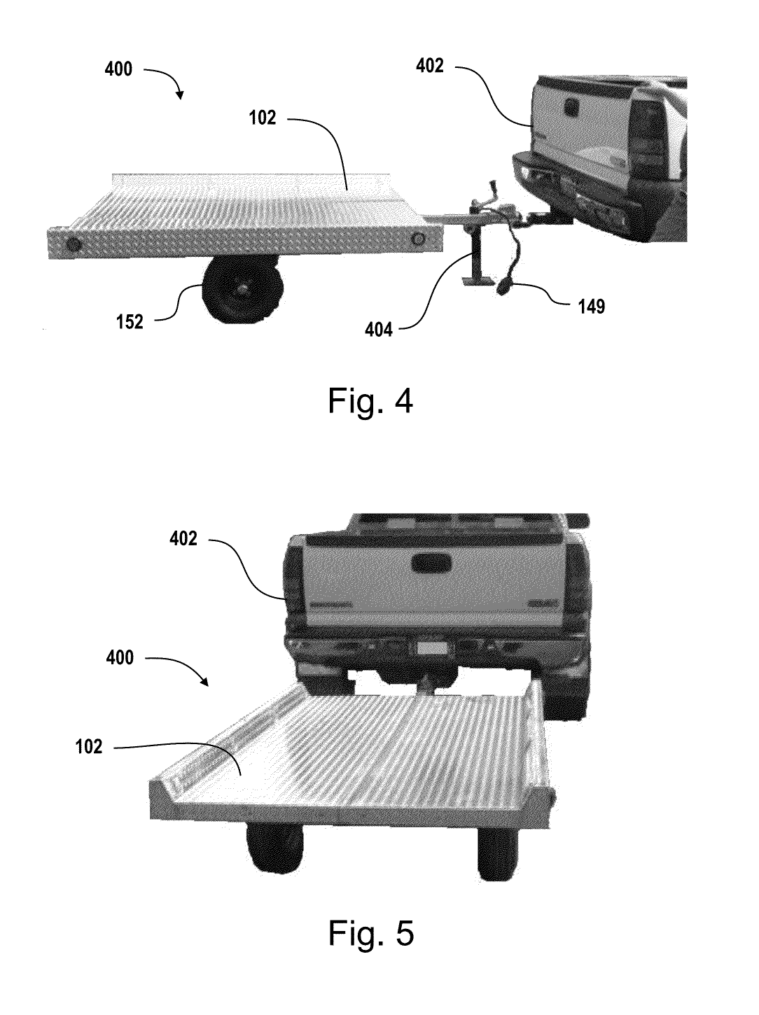

One or more tail and/or side lights 148 can be mounted on bed 102 so as to make apparatus 100 street legal. Lights 148 can be any type of tail or side light known in the art. An electrical coupler 149 (see FIG. 4) can also be included to electrically couple the lights to the towing vehicle, as is known in the art. In one embodiment, the electrical cords for the trailer connections to the truck can be retractable and/or coiled.

Wheel assembly 104 comprises one or more axles 150, each having one or more wheels 152 mounted thereon. For example, in the depicted embodiment, two axles 150 are used, each having a wheel 152 mounted on each end thereof. Wheel assembly 104 also includes mounting hardware 154 to mount the axles 150 to the bed 102. The axles 150, wheels 152, and mounting hardware 154 can comprise any type of trailer axles, wheels, and mounting hardware known by one skilled in the art. In one embodiment, tires 152 are big enough to allow apparatus 100 to be taken on the highway and can have a load capacity from 500 to 2,000 pounds or more.

Rack assembly 106 comprises a rack 160 and mounting hardware 162 for mounting the rack 160 to bed 102. Rack 160 can be used to tie down equipment positioned on bed 102 and can include ornamentation thereon. When Rack-N-Roll 100 is used as a truck bed cover, rack 160 can be used as a headache rack, in the manner known by one skilled in the art. Rack 160 is mounted to bed 102 using screws or other securing method.

Towing assembly 108 is used to couple Rack-N-Roll 100 to a truck, an ATV, or any other towing vehicle when Rack-N-Roll 100 is used as a trailer. Towing assembly 108 comprises a trailer tongue 170 with a trailer coupler 172 on the front end thereof. Trailer coupler 172 can comprise any type of trailer coupler known in the art for coupling a trailer to a vehicle. For example, trailer coupler 172 can include a cavity that is configured to receive and secure therein a standard 2-inch hitch ball or any other size of hitch ball, as is known in the art.

Trailer coupler 172 can be integrally formed with trailer tongue 170 or attached thereto, as is known in the art. When converting Rack-N-Roll 100 to a truck bed cover, towing assembly 108 can be removed from bed 102 to allow Rack-N-Roll 100 to be positioned within the bed of the truck, as discussed below. In one embodiment, towing assembly 108 can include a sleeve 174 which receives trailer tongue 170 therein in a telescoping manner. Sleeve 174 can be permanently attached to bed 102 and trailer tongue 170 can be slidable within sleeve 174. In that embodiment, trailer tongue 170 can be secured within sleeve 174 with a pin or the like, as is known in the art, when Rack-N-Roll is used as a trailer. Then, after trailer coupler is removed from trailer tongue 170, trailer tongue 170 can be slid into sleeve 174, instead of being removed, when converting Rack-N-Roll 100 to a bed cover.

Stabilizer jacks 112 can be used to stabilize bed 102 when Rack-N-Roll 100 is used as a truck bed cover, or when a tent or other device or equipment is positioned on bed 102, or anytime Rack-N-Roll is not coupled with a vehicle as a trailer. Stabilizer jacks 112 can be positioned on each corner, as in the depicted embodiment, or any other location of bed 102. Stabilizer jacks 112 can be retractable so they can be permanently mounted on bed 102, or they can be non-retractable such that they are removed from bed 102 when not in use. Any stabilizer jack used for trailers can be used and would be known to one skilled in the art.

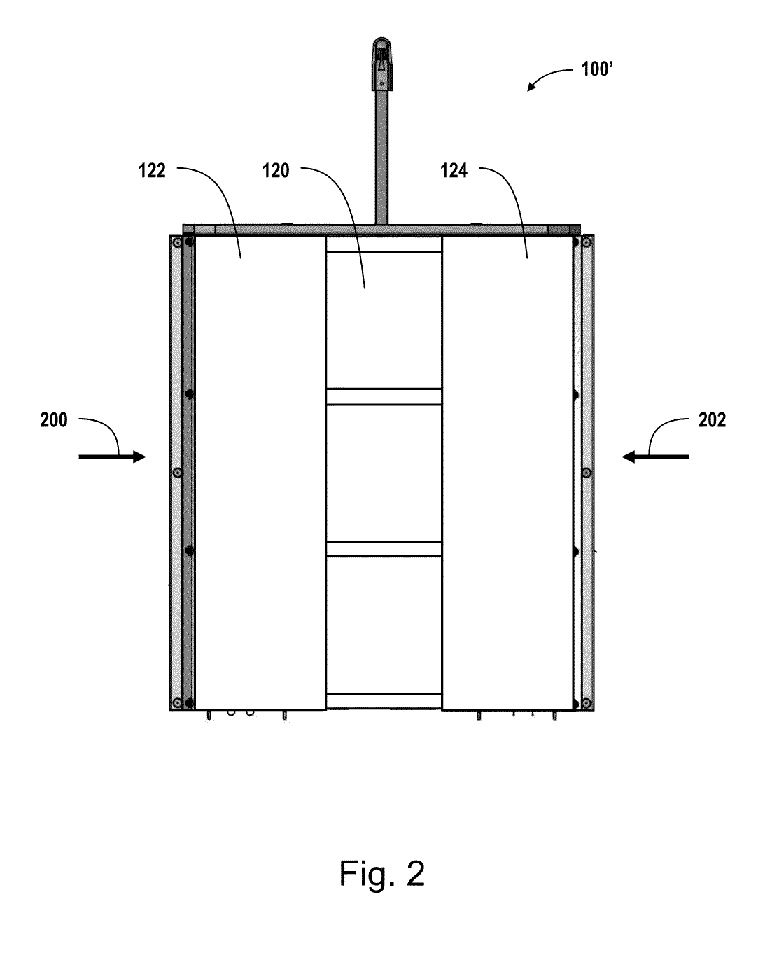

As discussed above, left and right side deck plates 122 and 124 can be laterally slid inward or outward (toward or away from each other, respectively) to change bed 102 between wide and narrow configurations. For example, FIG. 1C depicts Rack-N-Roll 100 in a wide configuration in which side deck plates 122 and 124 have been slid laterally outward to maximum or near maximum positions. In contrast, FIG. 2 depicts Rack-N-Roll 100 in a narrow configuration in which side deck plates 122 and 124 have been slid laterally inward (denoted by arrows 200 and 202) to minimum or near minimum positions. At the minimum positions (i.e., the narrowest configuration), the side deck plates 122 and 124 may contact each other, although that is not required. For ease of discussion, Apparatus 100 may be given the designation of 100′ in the narrow configuration herein.

To adjust the width of bed 102, fasteners, such as pins 144 shown in FIGS. 1A and 1B, can be removed from the front and rear ends of bed 102 and side deck plates 122 and 124 can be slid inward or outward, depending on the desired width, after which the pins can be reinserted. Pins 144 can extend through channels 130 and beams 136 when inserted to secure beams 136 to channels 130. If telescopic tubing is used for channels 130 and beams 136, the beams may need to be separately slid within channels 130.

In one embodiment, the bed 102 can be adjusted between about eight feet six inches in width to about four feet in width, with about six feet to about four feet being common. A six-foot width generally corresponds to a street-legal trailer width, and a four-foot width generally corresponds to a “mountain legal” width. Other widths are also possible. As a result of the width adjustments, Rack-N-Roll 100 can be pulled behind a truck (e.g., on the road) when the rack 100 is six-feet wide, and can be pulled behind an ATV (e.g., on a mountain trail) when the rack 100 is four-feet wide.

Apparatus 100 can be constructed of any material known in the art. In one embodiment, apparatus 100 is made of aluminum which is light and strong. This can allow a single person to be able to handle apparatus 100 by himself. This can be very beneficial when converting apparatus 100 between the various uses, discussed below. In one embodiment apparatus 100 can be made using telespar which allows adjustments in one-inch increments.

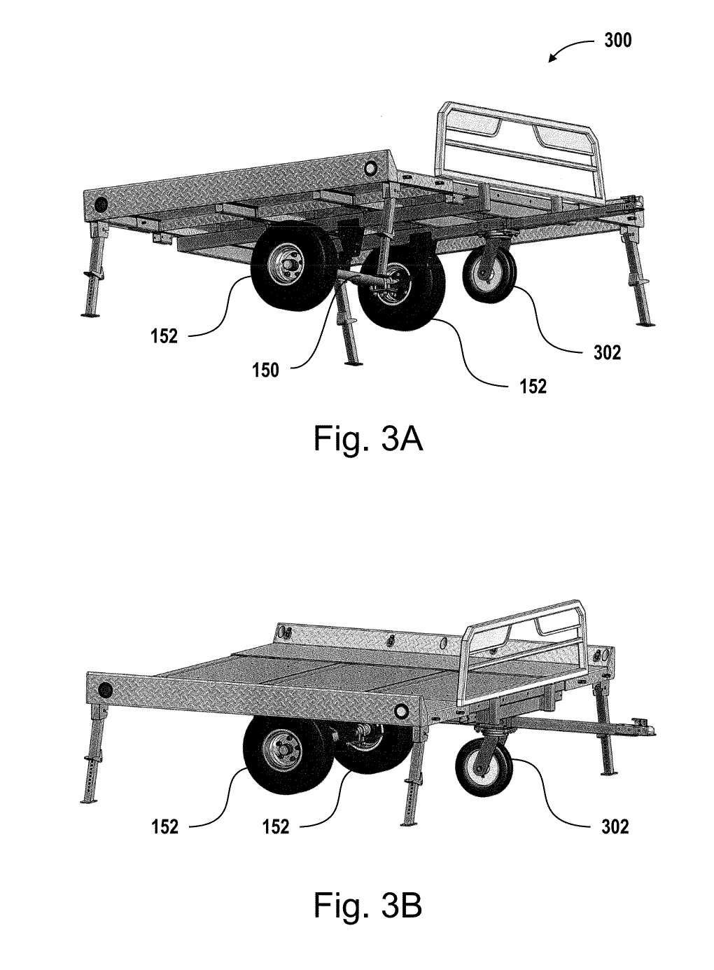

FIGS. 3A and 3B show another embodiment of an apparatus 300 that can convert between a truck bed cover and an adjustable trailer. Apparatus 300 is similar to apparatus 100, except that apparatus 300 incorporates only a single axle 150 and two wheels 152 for trailer use. One or more removable wheels 302 can be used to aid in converting apparatus 100 from a trailer to a truck bed cover, as discussed in more detail below. When apparatus 300 is used as a trailer, wheel 302 is removed therefrom. Wheels 302 can be designed to be easily attached to and detached from bed 102. For example, each wheel 302 can be mounted on a frame that can be easily attached to the underside of bed; a pin and a bolt can be used to secure each tire into place.

FIG. 4 depicts another embodiment of an apparatus 400 that can convert between a truck bed cover and an adjustable trailer. Apparatus 400 is similar to apparatus 300, except that in apparatus 400, rack assembly 106 has been omitted.

The following discussion concerns the many configurations for the Rack-N-Roll apparatus and the manners in which the apparatus can be converted between those different configurations. Although apparatus 400 is used for the following discussion, it will be appreciated that apparatuses 100 or 300 can also be used in a similar manner with minor variations dependent on the differences between the apparatuses.

As depicted in FIG. 4, apparatus 400 is in a trailer configuration, connected to a truck 402 using trailer coupler 172, in a standard manner. As such, wheel 302 is removed therefrom. A jack 404, positioned on trailer tongue 170, is in the down position so as to support bed 102. Before truck 402 begins towing apparatus 400, jack 404 can be removed or lifted off the ground, as is known in the art, and electrical coupler 149 can be electrically coupled to truck 402 in a standard manner.

In the configuration shown in FIG. 4, apparatus 400 can be a street legal size for a trailer. One or more all-terrain vehicles (ATVs), such as four-wheelers or the like, can fit on the bed 102 of the trailer. A snowmobile may also fit on the bed 102. In this configuration, the size of the bed can be about six to eight and a half feet wide, although other widths are also possible, as discussed above.

As noted above, the width of apparatus 400 can be adjusted so the trailer can be pulled on a mountain trailer by an ATV or a truck or other vehicle. To do so, pins 144 can be removed and side deck plates 122 and 124 can be moved laterally inward towards each other, as discussed above.

FIG. 5 depicts apparatus 400 in the narrow trailer configuration, being pulled by truck 402. In this configuration, the size of bed 102 can be about four feet wide, although other widths are also possible, as discussed above. In addition, in the narrow trailer configuration, apparatus 400 is ideal for being towed by an ATV.

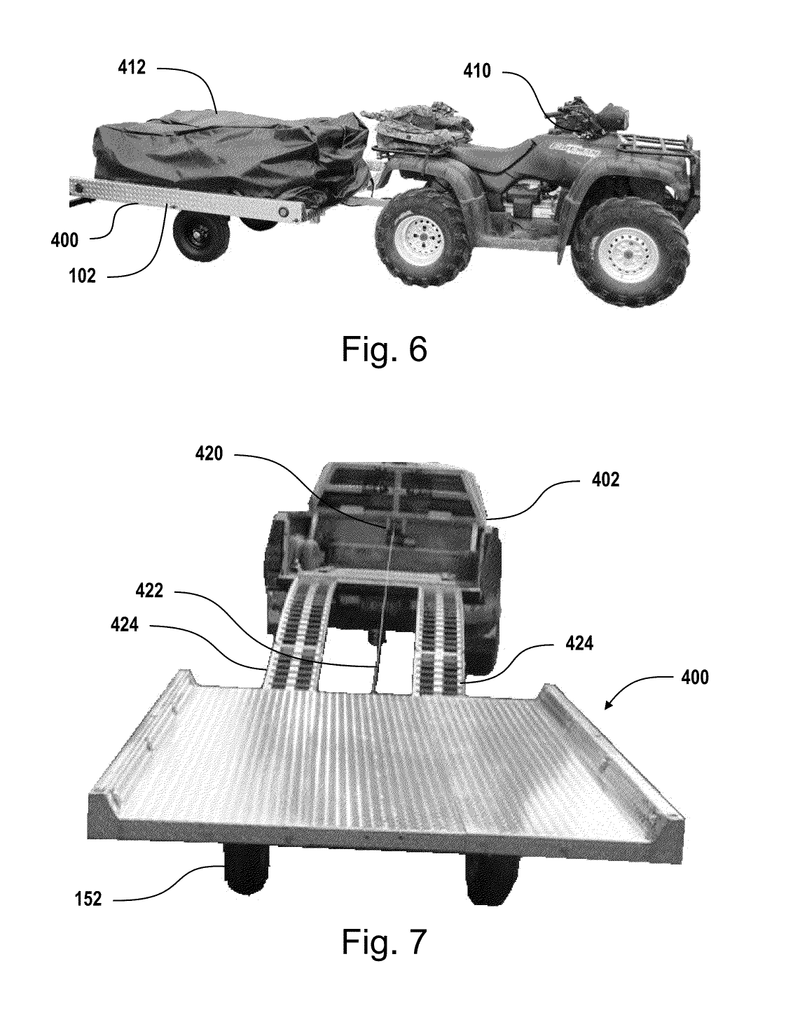

For example, FIG. 6 depicts apparatus 400 in the narrow trailer configuration, being pulled by an ATV 410. As shown in FIG. 6, a bag 412 or other equipment can be loaded onto apparatus 400 for hauling. Bag 412 can sit on the top surface of bed 102 and be secured thereto using attaching rings 142 positioned in the corners and sides of the bed 102. For example, rope or straps can attach to attaching rings 142. The ropes or straps can also cover the bag to further secure the bag to the bed 102. Being waterproof, the things will also not get wet. The width of the bed 102 can be adjusted for the size of the bag or other equipment.

As noted above, apparatus 400 can be converted from a trailer configuration to a truck bed cover configuration. To do so, the trailer tongue and coupler 170 and 172 are removed, or positioned back into bed 102, as discussed above. For example, in one embodiment, trailer tongue 170 can telescope into and out of bed 102.

If desired, extra wheels can be used to provide more stability while maneuvering bed 102 into position as a truck bed cover as well as to provide more support for loading equipment on bed 102 in the truck-bed-cover configuration. For example, when using apparatus 300 or 400, wheels 302 (FIG. 3A) can be attached to bed 102. Because apparatus 100 incorporates four wheels 152, extra detachable wheels may not be desired or needed.

With the trailer tongue and coupler out of the way, apparatus 400 can be maneuvered into position as a truck bed cover. In one embodiment, apparatus 400 can be positioned in the bed of a truck using a winch and some ramps.

FIG. 7 depicts one such embodiment. In the depicted embodiment, a winch 420 is secured to the back of truck 402 and a cable 422 extends from the winch. A pair of standard ramps 424 is positioned between truck 402 and apparatus 400 so as to be aligned with wheels 152 of apparatus 400 (and wheels 302, if used). Cable 422 can be attached to apparatus 400 and winch 420 can pull apparatus 400 up ramps 424 and into the bed of

Any standard winch will work, as long as the winch is rated high enough to the weight of apparatus 400 and anything positioned thereon. For example, in one embodiment a 3,000 pound winch can be used. Of course, other size winches will also work. The winch can be wired to a separate battery or directly to the truck battery. A remote control (not pictured) can be used to activate the winch, although this is not required.

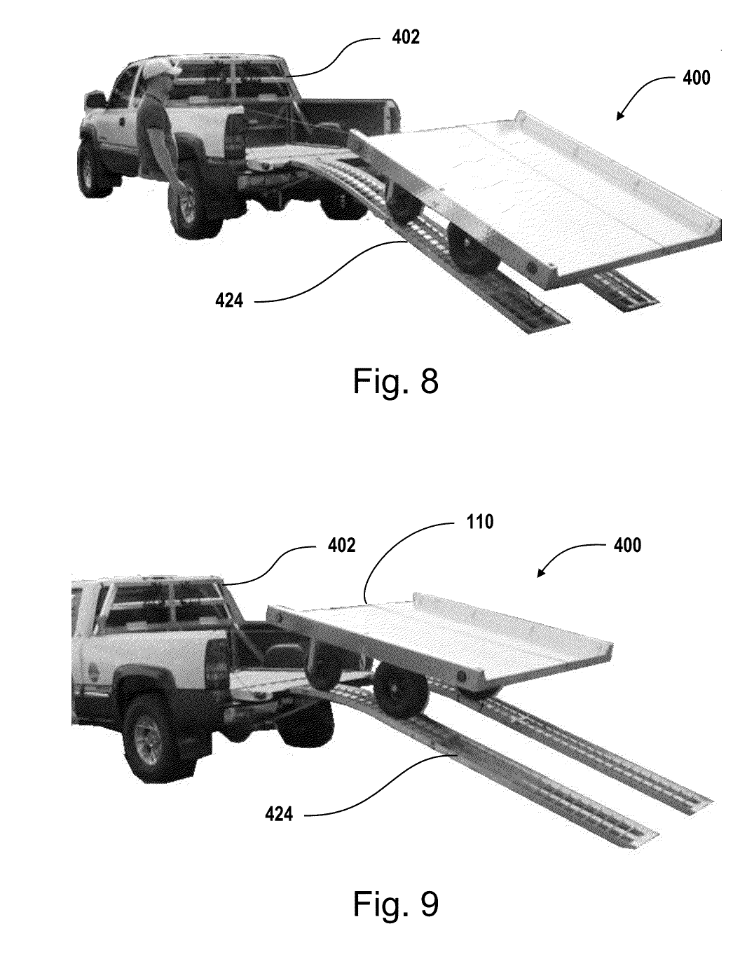

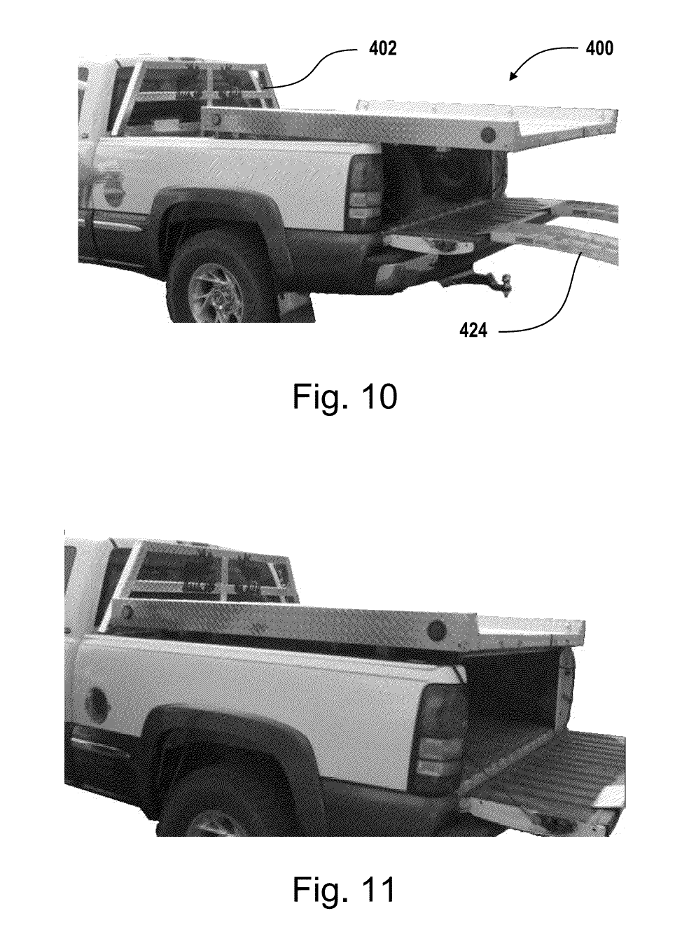

As shown in FIGS. 8-10, as winch 420 is activated, the cable 422 pulls apparatus 400 up the ramps 424 and into the back of the truck 402. Once inside the bed of the truck 402, the front end 110 of apparatus 400 can rest on brackets positioned in the bed of truck 402 on either side of the winch 420, if such brackets are used. Turnbuckles or other types of tie downs can be used to attach apparatus 400 to the rest of the truck bed. One benefit of embodiments of the present invention is that a single person can easily convert the apparatus to a truck bed cover and position the apparatus in the back of the truck.

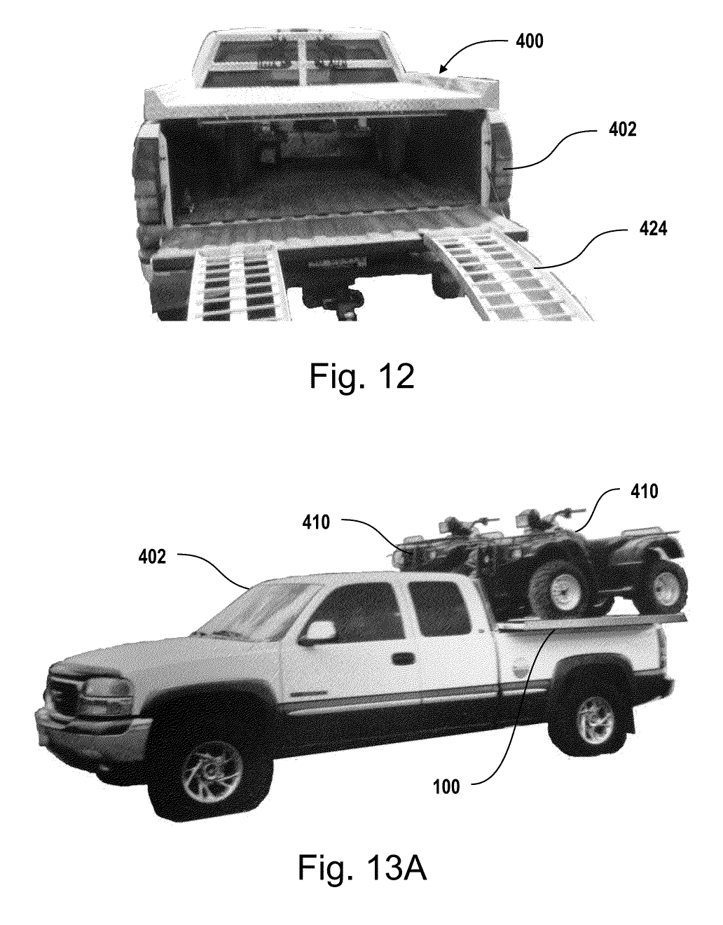

As shown in FIGS. 11 and 12, apparatus 400 is now a truck bed cover. Stabilizer jacks 112 that attach to the bottom of bed 102 can be extended to the truck bed surface to give apparatus 400 more stability when apparatus 400 is in the truck-bed-cover configuration and to allow apparatus 400 to support more weight.

In the embodiment discussed above, the winch is secured to the truck. In other embodiments, the winch can be a part of apparatus 400 and be attached to bed 102 or rack assembly 106, (if used). In that embodiment, cable 422 can be attached to the truck. Then, apparatus 400 can be pulled into the truck bed in a similar manner to that discussed above. In one embodiment, apparatus 400 is made of light materials, such as aluminum, and can be pushed up ramps 424 manually without using winch 420. In that case, winch 420 can omitted.

Although only two ramps 424 are used in the embodiment discussed above, apparatus 400 can also be modified to work with a standard tri-fold ATV ramp, or other ramp, if desired. In one embodiment, no winch is used and apparatus 400 is manually pushed up the ramps.

Any of the Rack-N-Roll apparatuses discussed or envisioned herein can be positioned in the bed of a truck whether the Rack-N-Roll apparatus is loaded or unloaded. This can be beneficial when positioning heavy loads, such as an ATV or a downed buck, on the bed of the Rack-N-Roll apparatus. The heavy load can be placed on the bed of the Rack-N-Roll apparatus while the apparatus is on the ground and then the Rack-N-Roll apparatus can be winched up into the truck in the manner discussed above. This can save a lot of headache and back problems that may come about by attempting to put the heavy load on the conventional truck bed cover that is four or five feet off the ground.

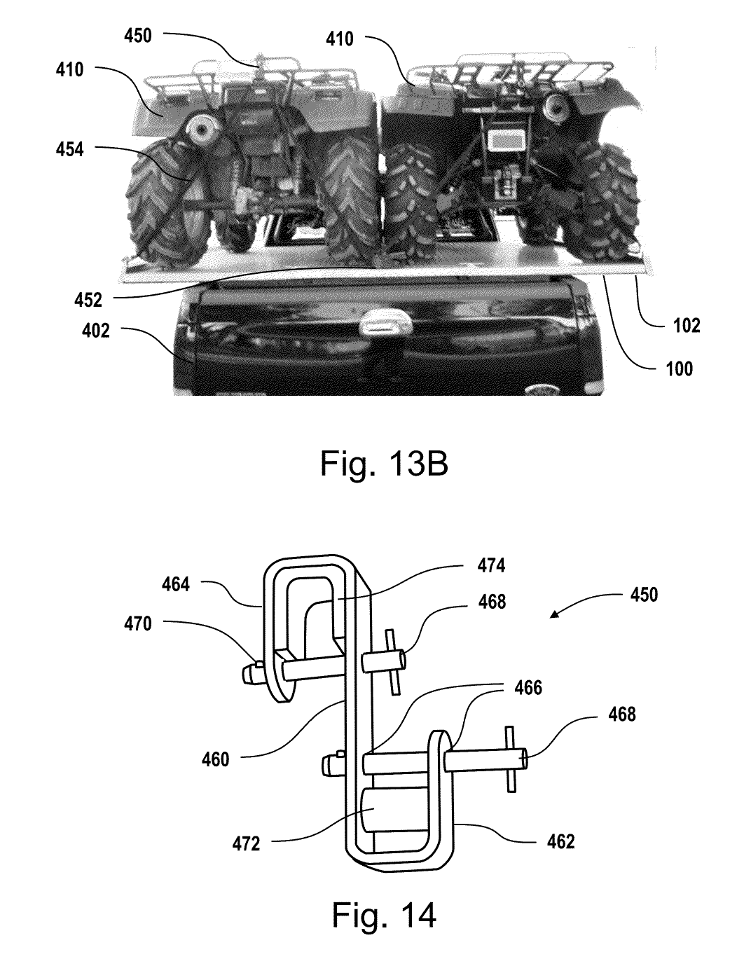

For example, FIGS. 13A and 13B depict one embodiment of a Rack-N-Roll apparatus 100 as a truck bed cover with a pair of ATVs 410 loaded side-by-side thereon. ATVs 410 were first positioned on apparatus 100 while apparatus 100 was positioned on the ground. Apparatus 100 could then be used as a trailer on which the ATVs were loaded. With the ATVs 410 positioned thereon, apparatus 100 was then positioned in the bed of truck 402 using a winch in a manner similar to that discussed above. Alternatively, apparatus 100 can be positioned as a truck bed cover before ATV's 410 are mounted thereon. FIG. 13B also shows that the Rack-N-Roll apparatuses can extend laterally outward over the walls of the bed of truck 402. In the depicted embodiment, bed 102 of apparatus 100 has been extended out to about eight and a half feet

FIG. 13B also shows an embodiment of an ATV tie-down bracketing system that can be used with the Rack-N-Roll apparatus. The bracketing system can comprise one or more tie down brackets 450 that can attach to the one or more ATVs 410, and a ratchet 452 that can be attached to the Rack-N-Roll bed 102. A strap 454 or the like can be used to couple tie down brackets 450 to ratchet 452, as shown in FIG. 13B. Each end of strap 454 can be attached to the Rack-N-Roll bed 102 and strap 454 can be tightened by manipulating ratchet 452. The ATV tie-down bracketing system can be used with other systems as well.

As shown in FIG. 14, each bracket 450 includes a main body 460 that is roughly in the form of an “s” to form first and second u-shaped channels 462 and 464. First channel 462 is configured to receive the tie down strap and second channel 464 is configured to attach to a rack on the ATV. Each channel 462 and 464 can include a pair of aligned throughholes 466 through which a pin 468 can be inserted. Each pin 468 is configured to remain within throughholes 466 until specifically removed, by including a spring loaded button 470 or the like, as is known in the art. A roller 472 can be positioned within first channel 462 to ease the movement of the tie down strap and a rubber pad 474 or the like can be positioned in second channel 462 to prevent scratching on the ATV.

The Rack-N-Roll apparatuses are designed to accommodate different sizes and shapes of truck beds. For example, in some embodiments, the Rack-N-Roll apparatus can be adjusted to fit different lengths of pickup beds by lengthening or shortening the Rack-N-Roll apparatus. For example, in one embodiment, the bed 102 of the Rack-N-Roll apparatus can be adjusted from about 5 feet to about 8 feet in length. This is in addition to the width adjustments discussed above. Furthermore, the tire frames can be adjusted to accommodate different truck bed heights.

Rack-N-Roll apparatus 400 can also be unloaded from the truck bed by using winch 420 in a generally opposite manner. To do so, winch 420 can be used to slowly allow gravity to pull apparatus 400 down ramps 424 until apparatus is again on the ground. If stabilizer jacks 112 have been extended to the truck bed surface, those jacks would be retracted before unloading apparatus 400 from the bed of the truck. Similar to loading, the Rack-N-Roll apparatuses can be empty or have a load positioned thereon during unloading.

To convert the Rack-N-Roll apparatus from a truck bed cover back to a trailer, the trailer tongue and coupler 170 and 172 are reattached to bed 102. Jack 404 can also be reattached to the tongue and rotated to support bed 102, as shown in FIG. 4. Once the tongue is supported, removable wheels 302 can be removed from bed 102, if wheels 302 have been used. Stabilizer jacks 112 can also be used, if desired.

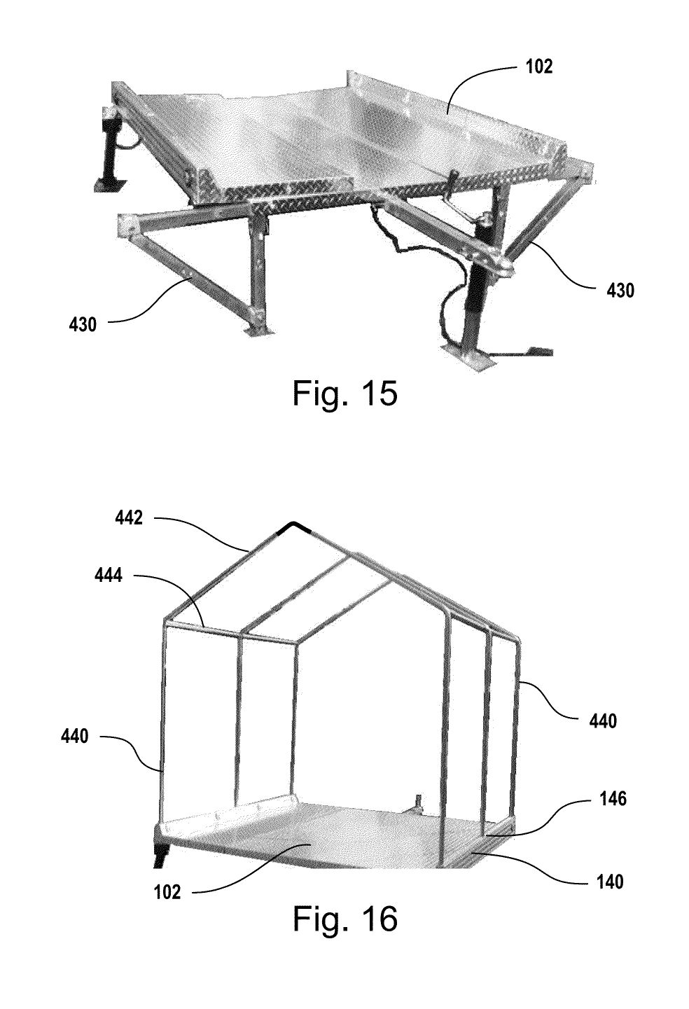

The Rack-N-Roll apparatus can also convert into a tent. Before putting up the tent, bed 102 must be moved to a desired width. In one embodiment, bed 102 is positioned in the wider position. One or more stabilizers 430 can be set up on the edges of bed 102 to provide more stabilization than stabilizer jacks 112 may provide, as shown in FIG. 15. Stabilizers 430 can provide the added stability desired when bed 102 is moved from the narrow configuration, shown in FIG. 15, to the wider configuration.

In one embodiment, stabilizers 430 can be slid into the ends of bed 102. Pins or other securing devices can then be used to secure stabilizers 430 to bed 102. Other supports can also be used to provide even more stability, if desired.

To construct the tent, a tubular framework can be mounted on bed 102, as shown in FIG. 16. The framework can comprise a number of vertical wall poles 440 to which ceiling poles 442 and connecting poles 444 are attached. The vertical poles 440 can be inserted into mounting holes 146 positioned on lips 140 of bed 102, as shown in FIG. 16. The rest of the poles 444 and 442 can be connected, either directly or indirectly, to the vertical poles 440.

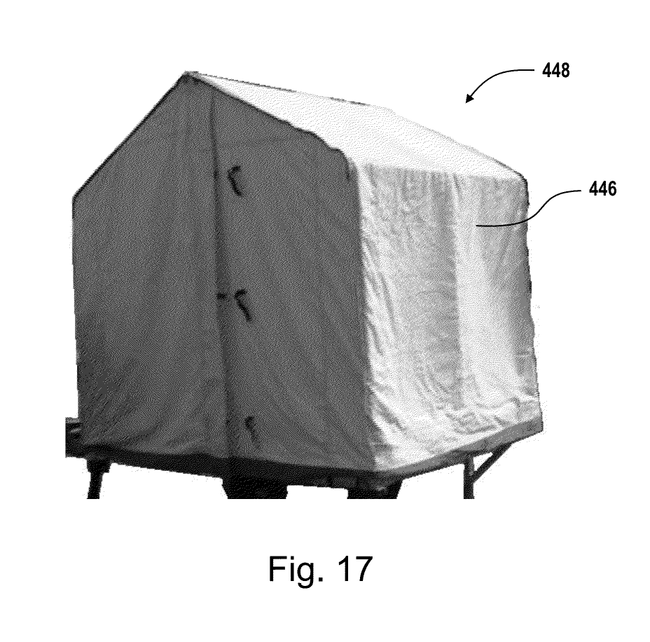

Once the framework is mounted and assembled, a canvas covering 446 is placed on the framework to complete the tent 448, as shown in FIG. 17. In the depicted embodiment, the walls of the tent are five feet tall. The tent can also have a removable awning. The awning can be attached to the tent using a zipper and a pair of poles can be used to stake down the awning, as is known in the art. One or more windows can be included in the tent for ventilation. Straps of the sides of the tent 448 can be hooked to attaching rings 142 on the sides of bed 102 or. In one embodiment, three people can comfortably sleep in the tent 448. Other tent configurations can also be used. For example, a tent that can be made from when the bed 102 is in the narrower position.

Tent 448 can be constructed and used while apparatus 100 is in the trailer configuration or in the truck bed cover configuration. If desired, tent 448 can be constructed while apparatus 100 is in the trailer configuration and then apparatus 100 can be converted to the truck bed cover configuration while tent 448 remains up on apparatus 100.

Using tent 448 while apparatus is in the truck bed cover configuration can allow for more insulation from the elements and allow equipment to be placed in the bed of the truck underneath the bed cover/tent.

As discussed herein, the Rack-N-Roll is a versatile apparatus. It can be a tent with or without an awning, it can be a street legal wide trailer, it can be a narrow trailer for an ATV, and it can be a truck bed cover that can fit various sizes of truck beds, to name just a few.

The present invention may be embodied in other specific forms without departing from its spirit or essential characteristics. Accordingly, the described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a bed having a top surface:
a wheel assembly attached to the bed: and
a towing assembly coupled with the bed, the towing assembly being configured to couple with a hitch of a vehicle;
wherein the apparatus is changeable between a trailer configuration, in which the apparatus is configured and usable as a trailer, and a truck bed cover configuration, in which the apparatus is configured and usable as a truck bed cover.

2. The apparatus recited in claim 1, wherein the bed comprises:
a center deck section; and
a pair of side deck sections positioned on either lateral side of the center deck section, top surfaces of the center deck section and the side deck sections combining to form the top surface of the bed, the side deck sections being slidably coupled to the center deck section such that the side deck sections can be slid laterally with respect to the center deck section to adjust the width of the apparatus.

3. The apparatus recited in claim 2, wherein the center deck section comprises a plurality of channels and the side deck sections each comprise a plurality of beams received within the channels, the beams being slidable within the channels to move the side deck sections laterally with respect to the center deck section.

4. The apparatus recited in claim 3, wherein the channels and beams comprise telescopic tubing.

5. The apparatus recited in claim 2, wherein the width of the apparatus is adjustable between about four feet to about eight and a half feet.

6. The apparatus recited in claim 1, wherein the wheel assembly comprising:
one or more axles; and
two or more wheels, each mounted to the one or more axles, the two or more wheels being configured to roll along the ground and support the bed when the apparatus is in the trailer configuration and to support the bed when the apparatus is in the truck bed cover configuration.

7. The apparatus recited in claim 1, wherein the towing assembly comprises:
a trailer tongue coupled with the bed; and
a trailer coupler positioned at the end of the trailer tongue, the trailer coupler being configured to couple with a hitch of a vehicle, wherein the trailer tongue and trailer coupler are configured to be adjusted or removed from the bed to place the apparatus in the truck bed configuration.

8. The apparatus recited in claim 6, wherein the towing assembly further comprises a sleeve attached to the underside of the bed, the sleeve receiving the trailer tongue in a telescoping manner.

9. The apparatus recited in claim 1, further comprising a rack assembly positioned at the front of the bed.

10. The apparatus recited in claim 1, further comprising a winch coupled to the bed.

11. A method comprising:
removing a towing assembly from an apparatus being used as a trailer;
positioning the apparatus into a bed of a truck; and
securing the apparatus to the truck bed to form a truck bed cover.

12. The method recited in claim 11, wherein positioning the apparatus into the bed of the truck comprises:
positioning one or more ramps to extend between the ground and the truck bed;
attaching a cable of a winch to one of the apparatus and the truck; and
activating the winch, which is secured to the other of the apparatus and the truck, to pull the apparatus up the ramps and into the bed of the truck.

13. The method recited in claim 11, further comprising adjusting a size of the apparatus.

14. The method recited in claim 13, wherein adjusting the size of the apparatus comprises adjusting the width of the apparatus to substantially match the width of the truck bed.

15. The method recited in claim 13, wherein adjusting the size of the apparatus comprises adjusting the length of the apparatus to substantially match the length of the truck bed.

16. The method recited in claim 11, further comprising positioning a load on the bed of the apparatus before the apparatus is positioned into the bed of the truck.

17. The method recited in claim 16, wherein positioning a load on the bed of the apparatus comprises positioning one or more all-terrain vehicles (ATVs) on the bed of the apparatus.

18. A trailer comprising:
a bed having a top surface, the bed comprising:
a center deck section; and
a pair of side deck sections positioned on either lateral side of the center deck section, top surfaces of the center deck section and the side deck sections combining to form the top surface of the bed, the side deck sections being slidably coupled to the center deck section such that the side deck sections can be slid laterally with respect to the center deck section to adjust the width of the trailer;
a wheel assembly attached to the bed, the wheel assembly comprising:
one or more axles; and
two or more wheels, each mounted to the one or more axles; and
a towing assembly coupled with the bed, the towing assembly comprising:
a trailer tongue coupled with the bed; and
a trailer coupler positioned at the end of the trailer tongue, the trailer coupler being configured to couple with a hitch of a vehicle.

19. The trailer recited in claim 18, wherein the width of the trailer is adjustable between about four feet to about eight and a half feet.

20. The trailer recited in claim 18, wherein the towing assembly further comprises a sleeve attached to an underside of the bed, the trailer tongue being slidable within the sleeve in a telescoping manner.
